(19) United States
(12) Patent Application Publication
(10) Pub. No.: US 2011/0117329 A1
(43) Pub. Date: May 19, 2011

(54) PRODUCTION OF CONDUCTIVE COATINGS BY MEANS OF INKJET PRINTING

(75) Inventors: Friedrich Jonas, Aachen (DE); Udo Guntermann, Krefeld (DE); Andreas Elschner, Muhlheim (DE); Detlef Riesebeck, Duisburg (DE); Detlef Gaiser, Koln (DE)

(73) Assignee: H.C. Starck Clevios GmbH, Goslar (DE)

(21) Appl. No.: 12/675,522

(22) PCT Filed: Jul. 28, 2008
(86) PCT No.: PCT/EP2008/059875

§ 371 Date: Dec. 14, 2010

(30) Foreign Application Priority Data
Aug. 29, 2007 (DE) 10 2007 041 039.7

(51) Int. Cl. B32B 3/14; B05D 5/12

(52) U.S. Cl. 428/195.1; 427/58

(57) ABSTRACT

The invention relates to a process for producing conductive coatings containing a dispersion or solution comprising at least one optionally substituted polythiophene, at least one polyanion, water, at least one solvent and at least one basic additive by means of inkjet printing, wherein the pH of the aqueous dispersion or solution is adjusted to a value between 2 and 10 by means of at least one basic additive. The invention also relates to a conductive coating and the use thereof.

The present invention relates to a novel process for producing conductive coatings by means of inkjet printing, to conductive coatings and to their use.

The production of conductive and/or antistatic coatings using dispersions or solutions comprising polyalkylenedioxythiophenes, especially 3,4-poly-ethylenedioxythiophene, is known, for example, from EP 0440 957.

EP 1112 673 describes a process for producing conductor tracks from dispersions comprising polyalkylene-dioxythiophene by inkjet printing.

In practice, however, it has been found that dispersions or solutions comprising polythiophene(s), especially polyalkylenedioxythiophene(s)—even when the dispersion or solution has been filtered beforehand—tend to block the print heads of the inkjet printer and hence make printing over a prolonged period impossible.

There was therefore a need for a process for producing conductive coatings by means of inkjet printing, in which the blockage of the print heads is prevented by the dispersion or solution used.

It was therefore an object of the present invention to provide such a process.

It has been found that, surprisingly, blockage of the print heads of an inkjet printer can be prevented when the dispersion or solution is neutralized before printing.

The present invention therefore provides a process for producing conductive coatings comprising a dispersion or solution comprising at least one optionally substituted polythiophene, at least one polyanion, water, at least one solvent and at least one basic additive by means of inkjet printing, characterized in that the pH of the aqueous dispersion or solution is adjusted to a value between 2 and 10 by means of at least one basic additive.

In the context of the invention, optionally substituted polythiophenes may preferably be optionally substituted polythiophenes containing repeat units of the general formula (I)

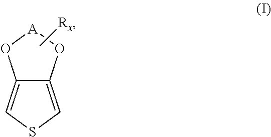

in which
A is an optionally substituted C₁-C₅-alkylene radical, preferably an optionally substituted ethylene or propylene radical,
R is a linear or branched, optionally substituted C₁-C₁₈-alkyl radical, preferably a linear or branched, optionally substituted C₁-C₁₄-alkyl radical, an optionally substituted C₅-C₁₂-cycloalkyl radical, an optionally substituted C₆-C₁₄-aryl radical, an optionally substituted C₇-C₁₈-aralkyl radical, an optionally substituted C₁-C₄-hydroxyalkyl radical or a hydroxyl radical,
x is an integer from 0 to 8, preferably 0, 1 or 2, more preferably 0 or 1, and
   in the case that a plurality of R radicals is bonded to A, they may be the same or different.

The general formula (I) should be understood such that the substituent R may be bonded x times to the alkylene radical A.

In the context of the invention, the aqueous dispersion or solution may also comprise a mixture of two or more different polythiophenes containing repeat units of the general formula (I).

In preferred embodiments, polythiophenes containing repeat units of the general formula (I) are those containing repeat units of the general formula (Ia)

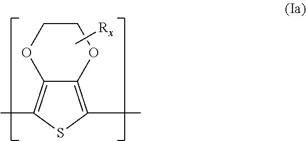

in which

R and x are each as defined above.

In further preferred embodiments, polythiophenes containing repeat units of the general formula (I) are those containing repeat units of the general formula (Iaa)

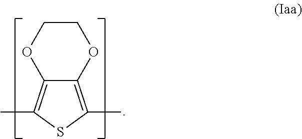

In the context of the invention, the prefix “poly” is understood to mean that more than one identical or different repeat unit is present in the polythiophene. The polythiophenes contain a total of n repeat units of the general formula (I), where n may be an integer from 2 to 2000, preferably 2 to 100. The repeat units of the general formula (I) may each be the same or different within a polythiophene. Preference is given to polythiophenes containing identical repeat units of the general formula (I) in each case.

On the end groups, the polythiophenes preferably each bear H.

In a particularly preferred embodiment, the polythiophene containing repeat units of the general formula (I) is poly(3,4-ethylenedioxythiophene), i.e. a homopolythiophene formed from repeat units of the formula (Iaa).

In the context of the invention, C₁-C₅-alkylene radicals A are methylene, ethylene, n-propylene, n-butylene or n-pentylene. In the context of the invention, C₁-C₁₈-alkyl represents linear or branched C₁-C₁₈-alkyl radicals, for example methyl, ethyl, n- or isopropyl, n-, iso-, sec- or tert-butyl, n-pentyl, 1-methylbutyl, 2-methylbutyl, 3-methylbutyl, 1-ethylpropyl, 1,1-dimethylpropyl, 1,2-dimethylpropyl, 2,2-dimethyl-propyl, n-hexyl, n-heptyl, n-octyl, 2-ethylhexyl, n-nonyl, n-decyl, n-undecyl, n-dodecyl, n-tridecyl, n-tetradecyl, n-hexadecyl or n-octadecyl, C₅-C₁₂-cycloalkyl represents C₅-C₁₂-cycloalkyl radicals, for example cyclopentyl, cyclohexyl, cycloheptyl, cyclooctyl, cyclononyl or cyclodecyl, C₅-C₁₄-aryl represents C₅-C₁₄-aryl radicals, for example phenyl or naphthyl, and C₇-C₁₈-aralkyl represents C₇-C₁₈-aralkyl radicals, for example benzyl, o-, m-, p-tolyl, 2,3-, 2,4-, 2,5-, 2,6-, 3,4-, 3,5-xylyl or mesityl. The list above serves to illustrate the invention by way of example and should not be considered to be exclusive.

Useful optional further substituents of the C₁-C₅-alkylene radicals A include numerous organic groups, for example alkyl, cycloalkyl, aryl, halogen, ether, thioether, disulphide, sulphoxide, sulphone, sulphonate, amino, aldehyde, keto, carboxylic ester, carboxylic acid, carbonate, carboxylate, cyano, alkylsilane and alkoxysilane groups, and also carboxamide groups.

The abovementioned dispersions or solutions, preferably comprising 3,4-polyalkylenedioxythiophenes, can be prepared, for example, in analogy to the process described in EP 440 957. Useful oxidizing agents and solvents likewise include those listed in EP 440957. The diameter distribution of the particles can be established, for example, by means of a high-pressure homogenization. The particle size in the swollen state is preferably less than 1 μm, more preferably less than 100 nm.

Processes for preparing the monomeric precursors for the preparation of the polythiophenes of the general formula (I) and derivatives thereof are known to those skilled in the art and are described, for example, in L. Groenendaal, F. Jonas, D. Freitag, H. Pielartzik & J. R. Reynolds, Adv. Mater. 12 (2000) 481-494 and literature cited therein.

The conductive polythiophenes may be uncharged or cationic. In preferred embodiments, they are cationic, in which case “cationic” refers only to the charges which reside on the polymer or polythiophene main chain. According to the substituent on the R radicals, the polymers or polythiophenes may bear positive and negative charges in the structural unit, in which case the positive charges are present on the polymer or polythiophene main chain and the negative charges may be present on the R radicals substituted by sulphonate or carboxylate groups. In this case, the positive charges of the polymer or polythiophene main chain may be partly or fully saturated by the anionic groups which may be present on the R radicals. Viewed overall, the polythiophenes in these cases may be cationic, uncharged or even anionic. Nevertheless, in the context of the invention, they are all considered to be cationic polythiophenes, since the positive charges on the polymer or polythiophene main chain are crucial. The positive charges are not shown in the formulae, since their exact number and position cannot be stated unambiguously. The number of positive charges is, however, at least 1 and at most n, where n is the total number of all repeat units (identical or different) within the polythiophene. Cationic polythiophenes are also referred to hereinafter as polycations.

To compensate for the positive charge, where this is not already done by the optionally sulphonate- or carboxylate-substituted and hence negatively charged R radicals, the cationic polymers or polythiophenes need anions as counterions.

Useful counterions preferably include polymeric anions, also referred to hereinafter as polyanions.

Suitable polyanions include, for example, anions of polymeric carboxylic acids, such as polyacrylic acids, polymethyacrylic acid or polymaleic acids, or anions of polymeric sulphonic acids, such as polystyrenesulphonic acids and polyvinylsulphonic acids. These polycarboxylic and polysulphonic acids may also be copolymers of vinylcarboxylic and vinylsulphonic acids with other polymerizable monomers, such as acrylic esters and styrene.

A particularly preferred polymeric anion is the anion of polystyrenesulphonic acid (PSS).

The molecular weight of the polyacids which are for the polyanions is preferably 1000 to 2 000 000, more preferably 2000 to 500 000. The polyacids or their alkali metal salts are commercially available, for example polystyrenesulphonic acids and polyacrylic acids, or else are preparable by known processes (see, for example, Houben Weyl, Methoden der organischen Chemie [Methods of Organic Chemistry], Vol. E 20 Makromolekulare Stoffe [Macromolecular substances], part 2, (1987), p. 1141 ff.).

Cationic polythiophenes which contain anions as counterions for charge compensation are often also referred to in the technical field as polythiophene/(poly)anion complexes.

In the aqueous dispersion or solution, the solids content of optionally substituted polythiophenes, especially of optionally substituted polythiophenes containing repeat units of the general formula (I), may be between 0.05 and 3.0 percent by weight (wt. %), preferably between 0.1 and 1.0 wt. %.

In another preferred embodiment of the present invention, the aqueous dispersion or solution comprises 3,4-poly(ethylenedioxythiophene) and polystyrenesulphonate.

Suitable solvents in the context of the invention are those solvents which are at least partly miscible with water, such as alcohols, e.g. methanol, ethanol, n-propanol, isopropanol, butanol or octanol, glycols or glycol ethers, e.g. ethylene glycol, diethylene glycol, propane-1,2-diol, propane-1,3-diol or dipropylene glycol dimethyl ether, or ketones, for example acetone or methyl ethyl ketone.

The content of solvent is between 0 and 90 wt. %, preferably between 5 and 60 wt. %. In the context of the invention, preference is given to using solvent mixtures of solvents having a boiling point below 100° C. and solvents having a boiling point above 100° C. at standard pressure.

The dispersion or solution may additionally comprise at least one polymeric binder.

Suitable binders are polymeric organic binders, for example polyvinyl alcohols, polyvinylpyrrolidones, polyvinyl chlorides, polyvinyl acetates, polyvinyl butyrates, polyacrylic esters, polyacrylamides, polymethacrylic esters, polymethacrylamides, polyacrylnitriles, styrene/acrylic ester, vinyl acetate/acrylic ester and ethylene/vinyl acetate copolymers, polybutadienes, polyisoprenes, polystyrenes, polyethers, polyesters, polycarbonates, polyurethanes, polyamides, polyimides, polysulphones, melamine-formaldehyde resins, epoxy resins, silicone resins or celluloses.

The solids content of polymeric binder is between 0 and 3 wt. %, preferably between 0 and 1 wt. %.

In the context of the invention, the dispersion or solution may further additionally comprise at least one dye and/or at least one surfactant. The content of dye may be between 0 and 5 wt. %, preferably between 0 and 0.5 wt. %. Useful dyes include, for example, azo dyes, azine dyes, anthraquinone dyes, acridine dyes, cyanine dyes, indigo dyes, nitro dyes, oxazine dyes, phthalocyanine dyes, phthalic acid dyes, polymethine dyes, thiazine dyes or triarylmethane dyes. The content of surfactant is between 0 and 5 wt. %, preferably between 0.01 and 0.5 wt. %. The surfactants may be anionic, cationic, nonionic or amphoteric surfactants, polyelectrolytes or block copolymers.

The dispersion or solution may additionally comprise adhesion promoters, for example organofunctional silanes or hydrolysates thereof, e.g. 3-glycidyloxypropyltrialkoxysilane, 3-aminopropyl-triethoxysilane, 3-mercaptopropyltrimethoxysilane, 3-methacrylpropyloxytrimethoxysilane, vinyltrimethoxysilane or octyltriethoxysilane.

The content of water in the dispersion or solution is calculated, taking account of the other constituents which are listed above, by the formula:

water content in wt. %=100−sum of the constituents in wt. %.

In the context of the invention, the basic additives used may be alkali metal hydroxides such as lithium hydroxide, sodium hydroxide, potassium hydroxide, alkali metal carbonates or alkali metal hydrogencarbonates such as lithium carbonate, sodium carbonate, potassium carbonate or caesium carbonate, alkaline earth metal hydroxides such as magnesium hydroxide, calcium hydroxide, barium hydroxide or strontium hydroxide, alkaline earth metal carbonates such as magnesium carbonate, calcium carbonate or barium carbonate, ammonia, aliphatic alkylamines, e.g. mono-, di- or trialkylamines with optionally substituted C₁-C₂₀-alkyl radicals, such as methylamine, dimethylamine, trimethylamine, ethylamine, diethyl-amine, triethylamine, ethanolamine, dimethyl-ethanolamine or triethanolamine.

The basic additives are preferably used in the form of a solution, for example in water and/or alcohols, to neutralize the dispersion or solution. Suitable alcohols are, for example, methanol, ethanol, n-propanol, isopropanol, butanol or octanol, glycols or glycol ethers, e.g. ethylene glycol, diethylene glycol, propane-1,2-diol or propane-1,3-diol.

In the process according to the invention, the basic additive is added to the dispersion or solution while monitoring the pH of the dispersion or solution with a pH meter, the addition preferably being effected with stirring. After the basic additive has been added, the pH of the dispersion or solution should be between 2 and 10, preferably between 4 and 9, more preferably between 6 and 8.

The amount of the basic additive to be used arises automatically from the acid content of the dispersion or solution before the neutralization. Per mole of acid to be neutralized, 0.05 to 1.0 mol, preferably 0.1 to 1.0 mol, of basic additive is added.

After the basic additive has been added, the dispersion or solution is filtered before printing. Suitable filters are, for example, polypropylene filters with a pore size below 1 μm, preferably below 0.5 μm, more preferably below 0.2 μm. The filtration can be effected under standard pressure or an elevated pressure of up to 10 bar.

Preference is given to passing the solution through the filters more than once, for example to pumping it through the filters in circulation.

The viscosity of the dispersions or solutions thus obtained is between 2 and 2000 mPas, preferably between 5 and 100 mPas, more preferably between 7 and 25 mPas.

In addition to the increased stability of the dispersions or solutions, the addition of the basic additive has the positive effect that the dispersions or solutions are less corrosive. The corrosion, especially of the print heads of the inkjet printer, is prevented or at least slowed as a result.

A further positive effect of the addition of the basic additive is that the substrate to which the dispersion is applied is not etched at all. In particular, conductive transparent inorganic layers (“transparent-conductive oxides”, TCO for short), such as indium tin oxide (ITO) or fluorine-doped zinc oxide (AZO) layers, tend to dissolve on contact with acidic solutions. This can result in contamination of the layers above with metal ions, which is disadvantageous for the function of the overall structure. The same applies to active matrix substrates composed of silicon, as are typically used as electric amplifier circuits in displays. The probability of any etching of the substrate is reduced by an increase in the pH.

The dispersions or solutions can be printed with commercial inkjet printers, for example from Dimatix. Suitable inkjet drop on-demand processes work with piezoelectric print heads or by the bubblejet process, as described, for example, in the journal ChipHeft 8 1994, p. 104-112. Inkjet printers which work by the continuous inkjet process can likewise be used.

The present invention further provides conductive coatings which may be flat or structured, and which are produced by the process according to the invention.

The conductive coatings produced by the process according to the invention are suitable especially for producing printed circuits on polymers, for example polyester films, as used to produce transistors, field-effect transistors or integrated circuits based on organic semiconductors. The production of organic field-effect transistors by means of the inkjet process is described in detail, for example, in the article “Lithography-Free, self-aligned Inkjet Printing with Sub-Hundred-Nanometer Resolution”, C. W. Sele et al., Adv. Mater. 2005, 17, 997-1001.

In addition, the conductive coatings produced by the process according to the invention can be used to produce transparent electrodes or hole-injecting layers for inorganic or organic electroluminescent lamps or displays. The production of displays consisting of polymeric light-emitting diodes by means of the inkjet process is described in detail, for example, in the article “Precision ink jet printing of polymer light emitting displays”, J. F. Dijksman et al., J. Mater. Chem. 2007, 17, 511-522.

### EXAMPLES

### Comparative Example 1

A 10 l beaker was initially charged with 2560 g of Baytron® PH 510 (H. C. Starck GmbH) with a solids content of 1.6%. While stirring with a gate stirrer, in the sequence specified,

100 g of dimethyl sulphoxide
8.0 g of Dynol 604 (from Air Products)
400 g of diethylene glycol
2180 g of water
1000 g of ethanol
2.0 g of n-octanol and
2.0 g of Triton X 100 (from Aldrich)
were added. The dispersion was subsequently stirred for min and then filtered through a filter cartridge from L&Z with a pore diameter of 0.2 μm at a throughput of 14 l/hour for 6 h.

### Example 1

A dispersion was prepared as in Comparative Example 1, with the difference that, before the filtration, the pH of the dispersion was adjusted to 7 by adding 50% aqueous dimethylethanolamine solution with stirring. After adjustment of the pH, the dispersion was filtered as in Comparative Example 1.

### Example 2

In each case 1.5 ml of the dispersions according to Comparative Example 1 and Example 1 were filled into one inkjet printer cartridge each of the Dimatix DMP 2831 inkjet printer. The cartridge was placed into the printer and a 2×2 cm² area was printed. This printing was repeated until the area was no longer completely filled or a loss of intensity became visible. The printing was effected onto a 175 μm-thick polyester film or onto paper.

TABLE 1

| Example | Number of full-area prints |
|---|---|
| Comparative example | 5 |
| Example 1 | 20 |

As the results in Table 1 show, using the dispersion prepared according to Example 1, better print results can be achieved than using the dispersion prepared according to the comparative example.

1.-10. (canceled)

11. A process for producing conductive coatings comprising a dispersion or solution comprising at least one optionally substituted polythiophene, at least one polyanion, water, at least one solvent and at least one basic additive by means of inkjet printing, wherein the pH of the aqueous dispersion or solution is adjusted to a value between 2 and 10 by means of at least one basic additive.

12. The process according to claim 11, wherein said at least one optionally substituted polythiophene is an optionally substituted polythiophene containing repeat units of the general formula (I) 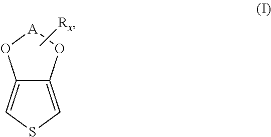
in which
A is an optionally substituted C₁-C₅-alkylene radical,
R is a linear or branched, optionally substituted C₁-C₁₈-alkyl radical, an optionally substituted C₅-C₁₂-cycloalkyl radical, an optionally substituted C₆-C₁₄-aryl radical, an optionally substituted C₇-C₁₈-aralkyl radical, an optionally substituted C₁-C₄-hydroxyalkyl radical or a hydroxyl radical,
x is an integer from 0 to 8 and
in the case that a plurality of R radicals is bonded to A, they may be the same or different.

13. The process according to claim 11, wherein said at least one polythiophene is a polythiophene containing repeat units of the general formula (Iaa)

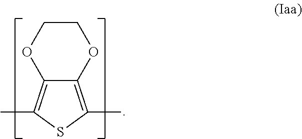

14. The process according to claim 11, wherein the aqueous dispersion or solution comprises 3,4-poly(ethylenedioxythiophene) and polystyrene sulphonate.

15. The process according to claim 11, wherein at least one basic additive is selected from the group consisting of alkali metal hydroxide, alkali metal carbonate, alkaline earth metal hydroxide, alkaline earth metal carbonate, ammonia and aliphatic alkylamine.

16. The process according to claim 14, wherein at least one basic additive is selected from the group consisting of alkali metal hydroxide, alkali metal carbonate, alkaline earth metal hydroxide, alkaline earth metal carbonate, ammonia and aliphatic alkylamine.

17. The process according to claim 11, wherein the pH of the aqueous dispersion or solution is adjusted to a value between 6 and 8 by means of at least one basic additive.

18. The process according to claim 16, wherein the pH of the aqueous dispersion or solution is adjusted to a value between 6 and 8 by means of at least one basic additive.

19. The process according to claim 11, wherein the aqueous dispersion or solution additionally comprises at least one polymeric binder.

20. The process according to claim 18, wherein the aqueous dispersion or solution additionally comprises at least one polymeric binder.

21. The process according to claim 11, wherein the aqueous dispersion or solution additionally comprises at least one surfactant and/or at least one dye.

22. The process according to claim 20, wherein the aqueous dispersion or solution additionally comprises at least one surfactant and/or at least one dye.

23. A conductive coating produced by the process according to claim 11.

24. A conductive coating produced by the process according to claim 22.

25. A transistor, a field-effect transistor, an integrated circuit, a transparent electrode, an inorganic electroluminescent arrangement or an organic electroluminescent arrangement which comprises utilizing the conductive coating according to claim 23.
